(19) United States
(12) Patent Application Publication
(10) Pub. No.: US 2013/0117142 A1
(43) Pub. Date: May 9, 2013

(54) SYSTEM AND METHOD OF AUTOMATICALLY MATCHING CARGO CARRIERS TO SHIPPERS

(71) Applicants: Micky L. Thompson, Tucson, AZ (US); Jarret D. Hamstreet, Tucson, AZ (US)

(72) Inventors: Micky L. Thompson, Tucson, AZ (US); Jarret D. Hamstreet, Tucson, AZ (US)

(21) Appl. No.: 13/667,560

(22) Filed: Nov. 2, 2012

Related U.S. Application Data
(60) Provisional application No. 61/555,158, filed on Nov. 3, 2011.

(51) Int. Cl. G06Q 50/28; G06Q 30/08

(52) U.S. Cl. 705/26.3; 705/334

(57) ABSTRACT

A method of identifying prospective carriers or brokers for transporting a load of freight comprises profiling a plurality of carriers or brokers via a website portal established by a hosting service wherein each carrier is profiled according to freight accommodations, trailer type, and geographic transport preferences, receiving parameters via the website portal from a shipper for the load of freight as to load size, required equipment type, shipper type, and origin and destination, performing a matching function by which the load is matched with carrier or broker profiles according to the load profile and determining the carriers or brokers that have profiles that match the load parameters, and notifying the matching carriers or brokers of the matching load parameters.

### RELATED APPLICATION

This non-provisional patent application claims the benefit of U.S. Provisional Patent Application, Ser. No. 61/555,158 filed on Nov. 3, 2011.

### FIELD

The present disclosure relates to a system and method of automatically matching cargo carriers to shippers in the freight transportation industry.

### BACKGROUND

The conventional way of matching shippers and carriers online has been through the use of “online load boards.” Online load boards are similar to classified ads (e.g., Craigslist) posted to a bulletin board, where shippers can advertise their available loads and carriers may manually search for and review loads.

A load board transaction begins when a shipper, or oftentimes a freight broker acting on behalf of a shipper, posts a load of freight to the load board. A typical load posting will include details about the load's origin and destination, weight and volume, and equipment necessary to transport the load. Typically, the origin and destination posting only specifies the city and state, as most load boards do not provide the ability to disclose addresses.

Load boards may have shippers, brokers, and carriers who subscribe to the load board. These users may pay a monthly subscription fee for the privilege to access the load board via the Internet. After logging into the load board, carriers and brokers find loads by reviewing a list of all available loads, or conducting a search by manually entering desirable load characteristics and narrowing the list of available loads to only those loads that match the desirable characteristics. Carriers must conduct a manual search for each type of load that they would like to haul.

Once a carrier finds a load that it would like to haul, an employee of the carrier must call, fax, or email the shipper to express interest. The carrier typically does not submit its price to haul the load via the load board, but instead engages in a traditional “back and forth” negotiation process with the shipper.

According to carriers and brokers that utilize load boards, a major weakness of the load board is that they must continuously visit the load boards to review lists of loads and conduct manual searches to see if any desirable loads have been posted to the load board. Operations personnel within carriers and brokers complain of the large amount of time that they “waste” in having to visit and review the load boards.

### BRIEF DESCRIPTION OF THE DRAWINGS

FIG. 1 is a simplified block diagram of an exemplary embodiment of a system of automatically matching cargo carriers to shippers;

FIG. 2 is a simplified flowchart of an exemplary method of receiving user registration;

FIG. 3 is a simplified flowchart of an exemplary method of automatically matching cargo carriers/brokers to shippers;

FIG. 4 is a simplified flowchart of an exemplary method of receiving bidding and awarding loads;

FIG. 5 is an exemplary screen portion for setting a Freight Alarm alert;

FIG. 6 is an exemplary screen portion for selecting a load size preference;

FIG. 7 is an exemplary screen portion for selecting a trailer type preference;

FIG. 8 is an exemplary screen portion for selecting a shipper type preference;

FIG. 9 is an exemplary screen portion for selecting the timing preference for receiving freight alarms.

FIG. 10 is an exemplary screen portion for selecting pickup and delivery location preferences;

FIG. 11 is an exemplary screen portion for bidding with and without equipment;

FIG. 12 is an exemplary screen portion for acceptance of bidding with and without equipment; and

FIG. 13 is an exemplary screen portion for selecting pickup and delivery location preferences with a radius allowance.

### DETAILED DESCRIPTION

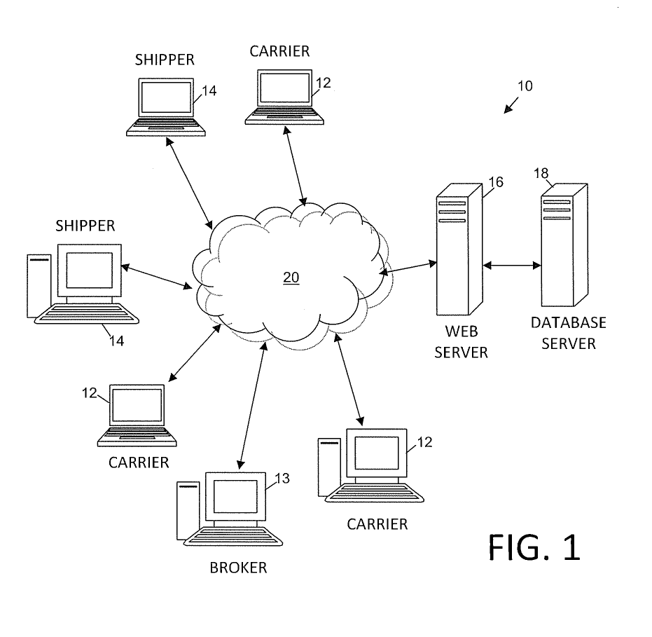

FIG. 1 is a simplified block diagram of an exemplary embodiment of a system 10 of automatically matching cargo carriers 12 and brokers 13 to shippers 14. In general, the term “carrier” is used herein to refer to a trucking company, and the term “shipper” is used herein to refer to a company that engages a carrier to transport a load of freight. The term “broker” is used herein to refer to an entity that may represent and act on behalf of a carrier or a shipper. The phrase “Third Party Logistics” or “3PL” or “TPL” is often used in the freight industry in the place of “broker.”

The system 10 includes a web server 16 in communication with a database server 18. The web server 16 is further in communication with the Internet 20 to permit the carriers 12, brokers 13, and shippers 14 to access resources residing therein. The web server 16 includes data and content organized on one or more web pages associated with one or more websites (e.g., www.postbidship.com) that are accessible and viewable by the carriers 12, brokers 13, and shippers 14 using a web browser program executing on a computing device such as a personal computer, laptop, tablet computer, e-reader, smartphone, and other mobile devices now known and later developed. The carriers 12, brokers 13, and shippers 14 may also submit information and data to the web server 16 and the database server 18 using the web browser and other programs. The lines of communication between the carriers 12, shippers 14, and web server 16 may be wired (copper, fiber, etc.) or wireless (microwave, radio frequency, satellite, infrared, etc.), and may utilize any form of data communication pursuant to any network or communication protocol now known or to be developed.

The database server 18 is preferably coupled to the web server 16 via a computer network (local area network, metropolitan area network, wide area network, virtual private network, intranet, Internet, etc.). The database server 18 is operable to store data, and perform query and lookup functions. In particular, the database server 18 is operable to store profile data and load data relating to carriers 12, brokers 13, and shippers 14, including but not limited to company name, address, contact person, email address, landline telephone number, mobile telephone number and service provider, load preferences, trailer type preferences, pickup and delivery location preferences, and other information.

It should be understood that the system 10 may employ a single powerful server to perform the functions of both the web server 16 and database server 18. Alternatively, multiple computers may be employed to provide the web server functionality and/or the database server functionality. The web server 16 and database server 18 may reside behind a firewall or other forms of security measures. Data backup servers may be used as well as other data storage services such as cloud servers.

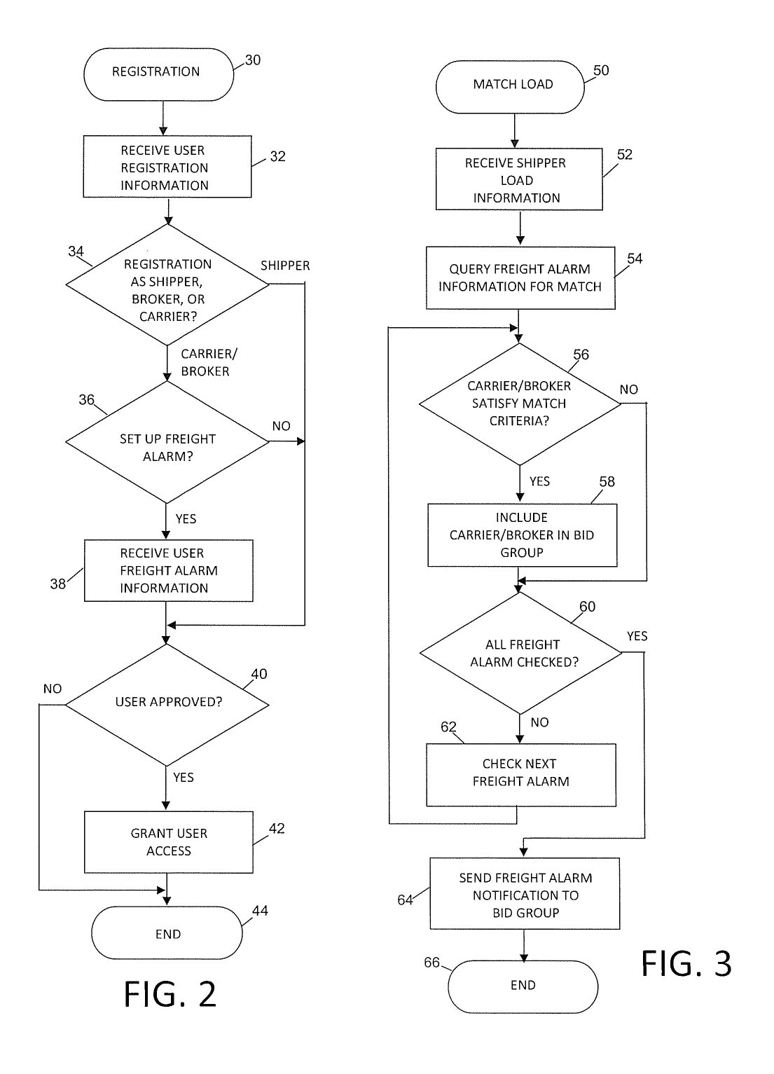

FIG. 2 is a simplified flowchart of an exemplary method 30 of receiving user registration. The method 30 begins in block 32 with a user accessing a web page and indicating or submitting a desire to register or creating an account with the system 10 as a shipper, broker or carrier. For example, the registration web page may require the user to select or click on a box associated with one of the categories of users. The user is also asked to furnish other data, such as name, company name, address, telephone number, email address, and password, etc. The method at block 34 determines whether the user is registering as a shipper, broker or carrier. If the user indicates a desire to register as a broker or carrier, then in block 36, a determination is made as to whether the user desires to provide information related to setting up a Freight Alarm alert. If the user desires to furnish information related to a Freight Alarm alert, then in block 38 one or more web pages designed to solicit user preferences are provided to the user for completion. If the user indicates a desire to register as a shipper, the user's data are furnished to a customer service representative for approval in block 40.

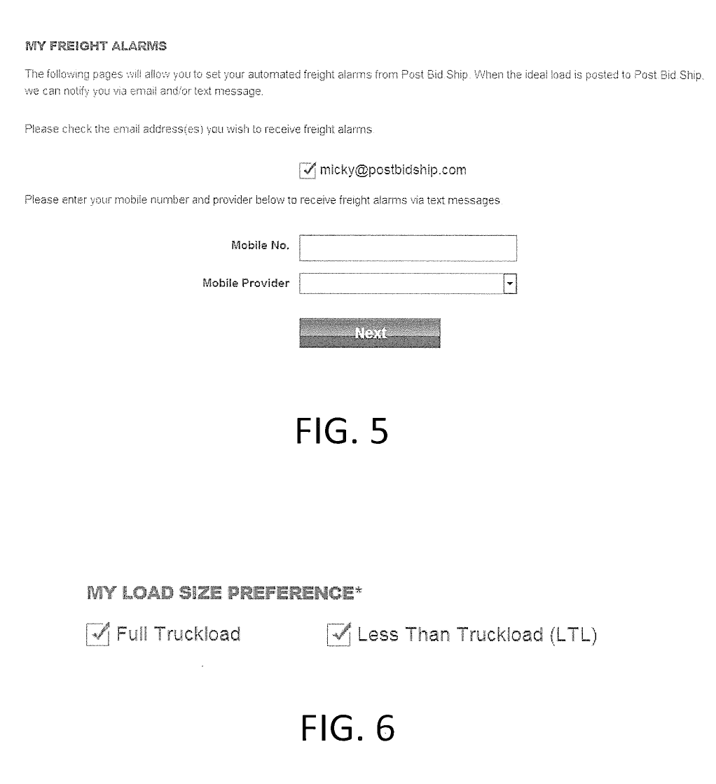

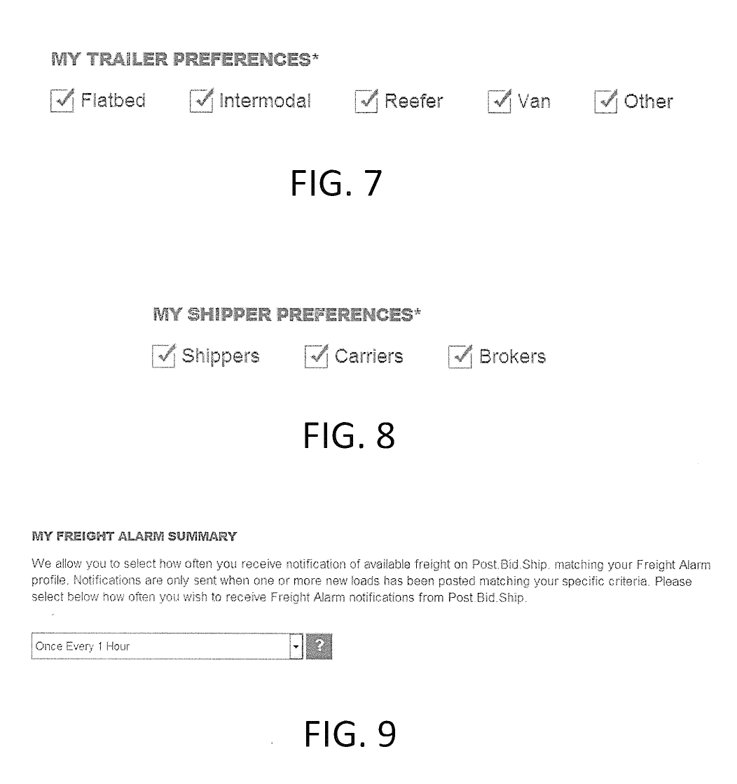

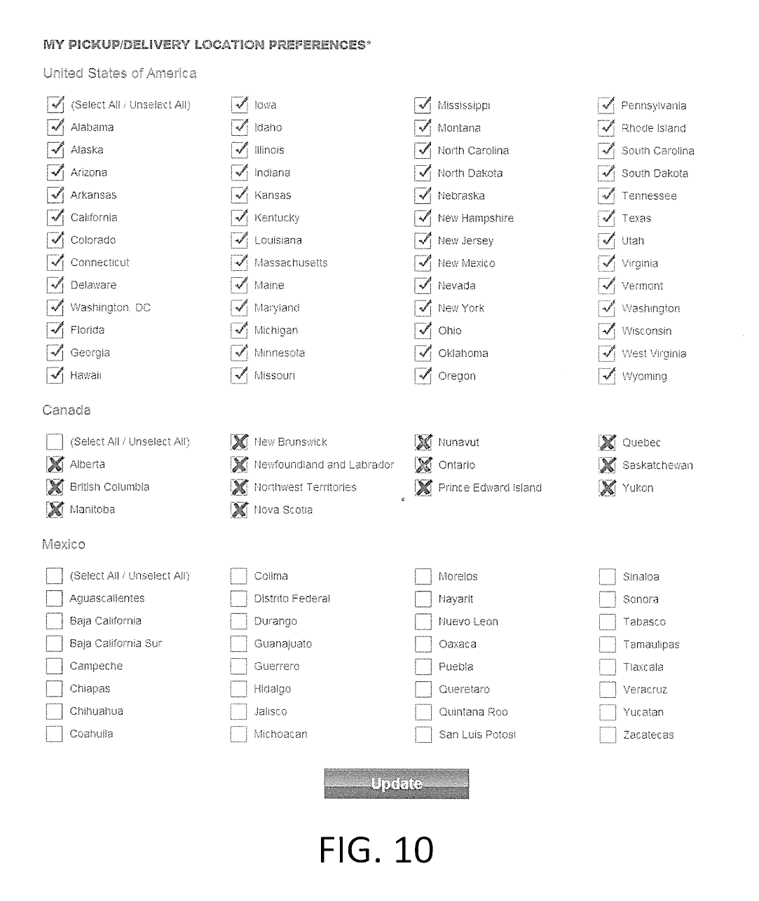

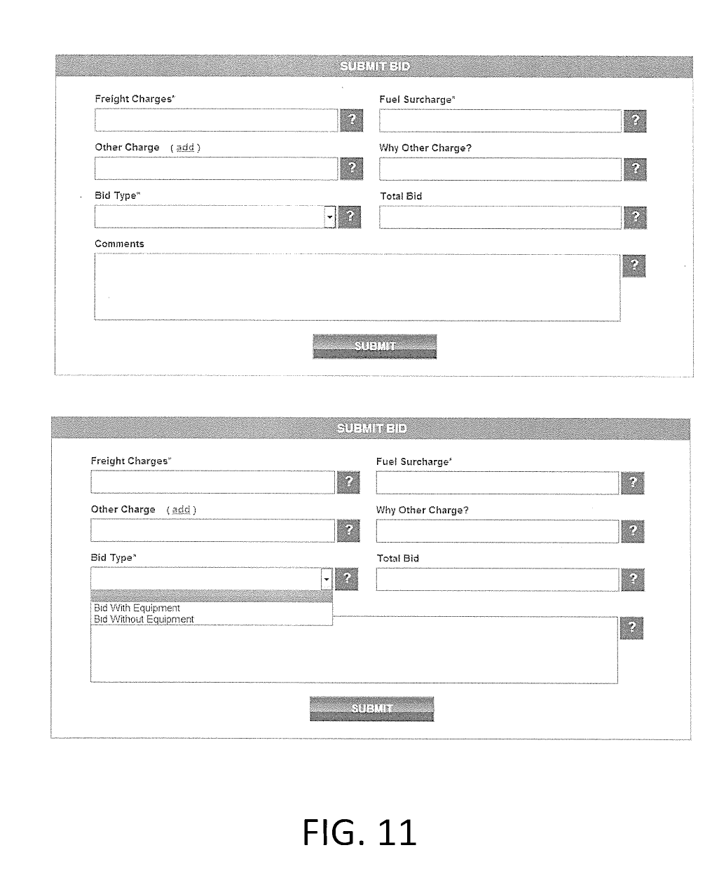

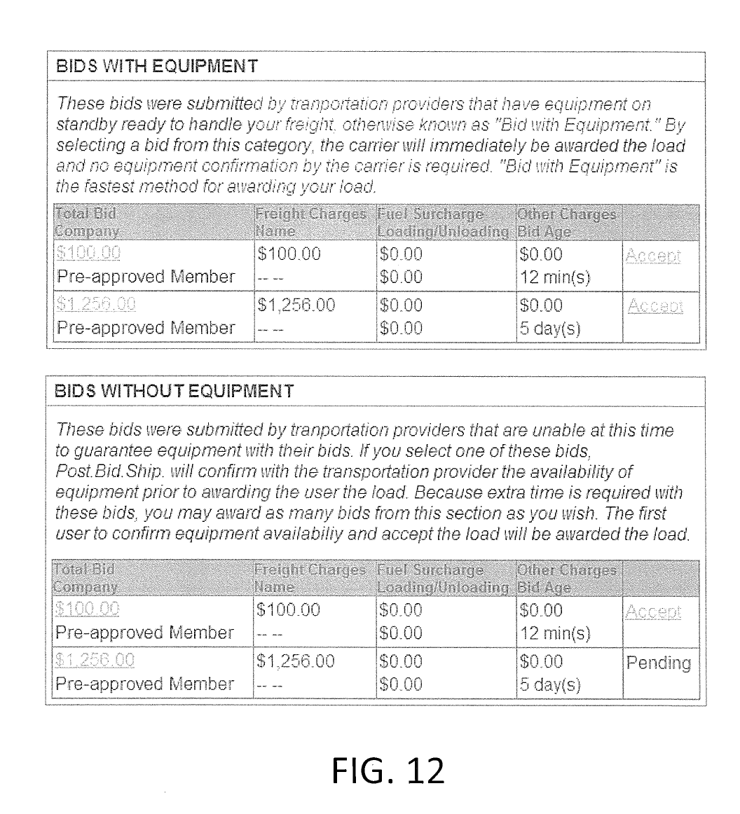

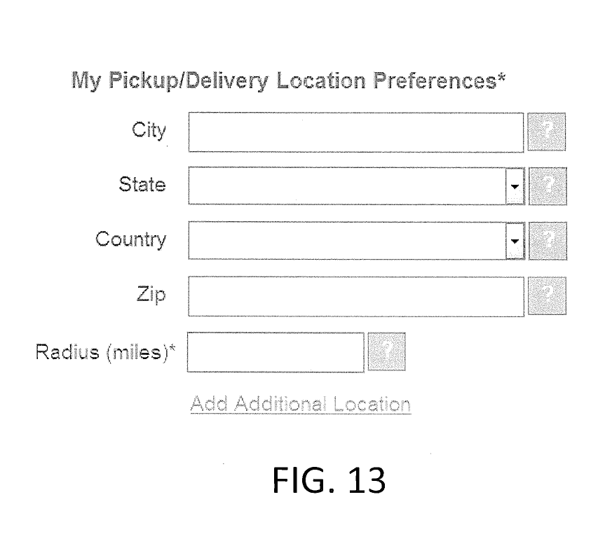

FIG. 5 is an exemplary screen portion for setting up a Freight Alarm alert by a carrier or broker. In this example, the user is asked to confirm the email address and/or mobile telephone number information. This information is used to provide notification to the carrier or broker. Additionally, FIG. 6 is an exemplary screen portion for selecting a load size preference. The user (carrier or broker) may indicate a preference for hauling full truckloads or less than truckloads. In FIG. 7 showing an exemplary screen portion for selecting a trailer type preference, the user may further indicate an availability of the type of trailer or equipment, such as flatbed, reefer, van, or another type of trailer. In the exemplary screen portion shown in FIG. 8, the user may further select the preferences for the type of shipper they wish to receive notifications regarding. A shipper type may be “direct” shippers (i.e. manufacturers or distributors of goods), carriers (i.e. trucking firms with more freight to haul than can be hauled by their own equipment), and/or brokers, (i.e. freight brokers who represent shippers). In the exemplary screen portion shown in FIG. 9, the user selects the frequency with which the user desires to be notified of loads that match the users Freight Alarm preferences. In the exemplary screen portion shown in FIG. 10, the user may further select the preferences for pickup and delivery locations. The service location preferences include an indication for one or more states in the United States, one or more provinces and territories of Canada, and one or more states of Mexico, for example. Although not explicitly shown, the service location preferences may include cities, counties, zip codes, and other regional or geographical designations where appropriate. The location preferences may also enable the carrier/broker to specify a radius from certain geographical points that it is willing to service, for example.

While setting their Freight Alarm preferences, the user may require a value be present within the load (e.g., requiring the load size to be ‘Full Truckload’), a value being present that will block the Freight Alarm from being sent (e.g., requiring load size to NOT be ‘Less Than Truckload’), or that a condition must be present before a Freight Alarm is sent (e.g., an origin state or a destination state must be within the country of Canada).

Returning to the exemplary flowchart in FIG. 2, once the user completes the registration information and the Freight Alarm alert preferences, the information is sent to a customer service representative to approve or deny registration. If the customer service representative did not approve the user's registration, as determined in block 40, then the user's registration is denied and the user is not granted access to the system. If the user's registration is approved, then the user's access to the system is enabled in block 42 and the registration process ends in block 44.

FIG. 3 is a simplified flowchart of an exemplary method 50 of automatically matching cargo carriers/brokers to shippers, which is performed as soon as a shipper posts a load. If the registered user is an approved shipper, then it is allowed to post a load in block 52. A load may have multiple commodity types having multiple different pickup and/or delivery points. The shipper provides information or criteria about the load, including for example, what is the commodity to be shipped, the trailer type required, the weight, the pickup and delivery locations, and the pickup and delivery dates. For each posted load, an automatic matching process 50 is performed in block 54 to determine whether the Freight Alarm alert information of a registered carrier or broker meet the criteria of the posted load. If a user's Freight Alarm alert information matches the posted load criteria in block 56, then that user is added to a bid group in block 58. The carriers and brokers in the bid group will be notified that the shipper is accepting bids.

The Freight Alarm alerts may be compared to the posted load criteria in a variety of ways. For example, a carrier or broker may specify Freight Alarm alert preferences that must all correspond to a posted load's criteria to generate a match. A carrier or broker may indicate in its Freight Alarm alert preferences that as long as one of its pick up or delivery points corresponds to the posted load criteria it is a match. Alternatively, a carrier or broker may allow for a match if both the pick up and delivery points of a posted load are within a 20 mile radius of its service location preferences, for example.

If a user's Freight Alarm alert preferences do not match the posted load criteria in block 56, then the match process determines whether all user Freight Alarm alerts have been checked in block 60. If not, then the method advances to the next Freight Alarm alert in block 62, and the process repeats until all Freight Alarm alerts have been compared against the posted load criteria. Once all the Freight Alarm alerts have been checked, the method automatically sends a notification to the registered carrier(s) and broker(s) in the bid group that matched the posted load criteria using the preferred notification method of each carrier and broker. Any communication method now known or later developed can be used to send the notification, such as email, text message, etc. The process ends in block 66.

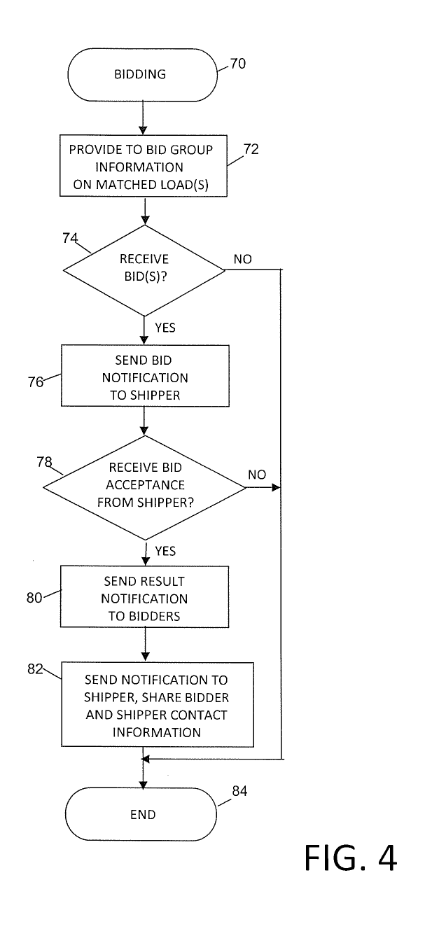

FIG. 4 is a simplified flowchart of an exemplary method 70 of receiving bids and awarding loads. In block 72, information of the matched load is provided or communicated to the carriers and brokers in the bid group. In block 74, a determination is made as to whether any carrier or broker in the bid group has submitted a bid to the shipper. A bid includes a transportation fee in exchange for which the carrier or broker is willing to transport the load according to the posted bid criteria. The bid may include other parameters. A time period may be imposed during which all bids must be received. If no bids are submitted and the shipper does not choose to extend the bidding period, then the process ends and an appropriate notification may be sent to the shipper. However, if at least one bid is received, then it is sent to the shipper in block 76. A determination is then made as to whether the shipper accepts one of the submitted bids in block 78. A time period may or may not be imposed during which the acceptance must be received. If there is no acceptance, then the process ends. If there is an acceptance, then in block 80 a notification is sent to the winning carrier or broker of its accepted bid, and appropriate notifications are sent to the losing bidders. In block 82, all the parties to the transaction are notified and informed of each other's identity so that they may communicate and make arrangements to proceed with the load. The process ends in block 84.

In one exemplary embodiment, the winning notification enables the carrier or broker to pay a transaction fee to proceed with the load, such as a percentage of the entire transportation fee. In another exemplary embodiment, a monthly subscription or access fee covers the bid posting and/or bid receiving activity and provides access to certain carrier/shipper/broker information (e.g., credit score, background information, safety statistics, etc.). The subscription fee may be tiered to differentiate service levels, access to certain information, and other privileges. A premium level of user access may grant the user access to certain proprietary data or information. For example, these data may include timing of loads based on seasonal fluctuation in the commercial transportation industry, placing difficult to cover freight where a user may have a competitive advantage to handle the freight shipment, or the ability to gain insight into marketplace data not readily available to all users. As a further example, a full service membership level may provide shippers, brokers, and carriers the ability to outsource common functions related to their role in shipping freight. Shippers and brokers may choose to outsource the management and oversight of their commercial freight, including selection of carriers to haul freight, processing the necessary paperwork and/or monitoring the movement of freight shipments. Brokers and carriers may choose to outsource the process for acquiring freight to be haul for their businesses. These offerings are included in a premium full service level for providing these outsourced services to shippers, brokers and carriers.

In another exemplary compensation model, the carrier or broker handling the load agrees to be paid earlier than the payment terms agreed to by the shipper of the freight. In return for being paid earlier, the carrier or broker agrees to forgo a percentage of the payment. The common terminology in the commercial freight industry for this transaction is referred to as ‘factoring a load.’ The company may offer factoring services to our winning bidders either through the company, 3rd parties, or both. For example, a shipper hires a carrier or broker to transport a load for a fee of $3,000 to be paid in 30 days. The carrier or broker needs cash sooner, so it sells the $3,000 receivable to the company acting as a financing/factoring company for $2,850 and collects the $2,850 from the company in 3 days. The carrier or broker assigns the $3,000 receivable to the company, which collects $3,000 from the shipper in 30 days.

FIG. 9 is an exemplary screen portion for bidding with and without equipment. In a preferred embodiment, the system 10 may provide a carrier or broker the ability to submit a “bid with equipment.” In other words, a bid may be submitted if the carrier or broker submitting the bid has reserved or committed specific equipment that can haul the posted load. This feature provides added assurance to the shippers that the carriers or brokers who bid on their loads actually have the equipment that can transport their loads.

The system 10 may also provide a carrier or broker to submit a “bid without equipment.” In other words, a bid may be submitted if the carrier or broker submitting the bid has not yet reserved or is unable at the time of submitting the bid to commit specific equipment that can haul the posted load. The “bid without equipment” specification provides additional information to the shippers that the carriers or brokers who bid on their loads may not yet have the equipment that can transport their loads. A shipper may choose to award the load to multiple “bid without equipment” users. In response to the selection by the shipper, the system 10 first requests the selected bidder(s) to secure the equipment or to withdraw its bid if it cannot secure the equipment. The system 10 awards the load to the first selected “without equipment” bidder that can confirm the reservation of equipment to handle the load.

An online shipper/carrier reputation rating may be instituted by the system 10. For example, carriers and shippers may give a star rating to parties with whom they have transacted business. The system 10 may send reminders to the shippers, carriers, and brokers at appropriate times to solicit rating input. For example, a reminder may be sent to a shipper after the indicated pick up date of a posted load to enable the shipper to rate how well the load pick up was performed. Another reminder may be sent to the shipper after the scheduled delivery date. A reminder may be sent to the carrier thirty days after load delivery, for example, to solicit evaluation on whether payment for the delivered load was timely. The reputation rating enables the registered users to transact business only with trusted parties. The reputation rating may enable a shipper to select a bidder with the best reputation. Further, a shipper may specify a minimum rating such that the matching process would only select carriers or brokers having a four star rating or better, for example.

The features of the present invention which are believed to be novel are set forth below with particularity in the appended claims. However, modifications, variations, and changes to the exemplary embodiments described above will be apparent to those skilled in the art, and the system and method of automatically matching cargo carriers to shippers described herein thus encompasses such modifications, variations, and changes and are not limited to the specific embodiments described herein.

What is claimed is:

1. A method of identifying prospective carriers or brokers for transporting a load of freight comprising:
profiling a plurality of carriers or brokers via a website portal established by a hosting service wherein each carrier is profiled according to freight accommodations, trailer type, and geographic transport preferences;
receiving parameters via the website portal from a shipper for the load of freight as to load size, required equipment type, shipper type, and origin and destination;
performing a matching function by which the load is matched with carrier or broker profiles according to the load profile and determining the carriers or brokers that have profiles that match the load parameters; and
notifying the matching carriers or brokers of the matching load parameters.

2. The method of claim 1, further comprising:
receiving one or more bids from the matching carriers or brokers;
notifying the shipper of the one or more bids; and.
providing bid information to the shipper.

3. The method of claim 1, wherein profiling a plurality of carriers or brokers comprises receiving a freight alarm notification method.

4. The method of claim 1, wherein profiling a plurality of carriers or broker comprises receiving one or more values that are required to be present in the received parameters of the load of freight.

5. The method of claim 1, wherein profiling a plurality of carriers or broker comprises receiving one or more conditions that are required to be present in the received parameters of the load of freight.

6. The method of claim 1, wherein profiling a plurality of carriers or broker comprises receiving one or more values that must not be present in the received parameters of the load of freight.

7. The method of claim 1, wherein profiling a plurality of carriers or broker comprises receiving one or more pickup/delivery location preferences.

8. The method of claim 1, wherein profiling a plurality of carriers or broker comprises receiving a load size preference.

9. The method of claim 1, further comprising registering the shippers, carriers, and brokers on a subscription fee basis.

10. The method of claim 1, further comprising registering the shippers, carriers, and brokers on a tiered subscription fee basis, where the membership levels are differentiated by amount and type of accessible data, and type and level of available services.

11. The method of claim 2, further comprising:
receiving an acceptance of a bid from the shipper; and
receiving a transaction fee from the carrier/broker that submitted the accepted bid.

12. The method of claim 2, further comprising:
receiving a request to finance shipping for the load of freight; and
receiving a compensation for financing the load of freight.

13. A system comprising:
a database server storing a plurality of records associated with a plurality of registered users, the plurality of registered users include shippers, carriers, and brokers, and the records associated with the registered carriers and brokers including contact information, notification preferences, load size preferences, trailer preferences, shipper preferences and transport service location preferences;
a web server storing a plurality of web pages associated with a web portal and in communications with the database sever and a global computer network, the web server further operable to:
receive a load of freight posting from a registered shipper via the global computer network, the load of freight posting including contact information and a set of load parameters including pick up and delivery locations, pick up and delivery dates, load size, and trailer type;
immediately and automatically search the plurality of records associated with registered carriers and brokers, and identify those registered carriers and brokers having preferences matching the load parameters;
automatically send notifications to the registered carriers and brokers having matching preferences;
receive bids from the registered carriers and brokers having matching preferences;
automatically send the received bids to the shipper;
receive an acceptance from the shipper of a bid submitted by a winning bidder;
immediately and automatically send a notification to the winner bidder, and notifications to the remaining bidders; and
provide the contact information of the winning bidder and the shipper to one another.

14. A computerized method of identifying carriers or brokers for transporting a load of freight comprising:
receiving and storing a plurality of registration profiles including notification method preference, load size, trailer type, shipper preferences and geographic transport preferences of a plurality of carriers;
receiving load criteria from a shipper for the load of freight as to weight, required equipment type, and load pickup and delivery points;
comparing the plurality of carrier profiles to the load criteria to identify carriers that have profiles that match the load criteria;
automatically notifying the matching carriers or brokers of the matching load criteria according to their respective notification method preferences;
receiving bids from the matching carriers or brokers and sending the bids to the shipper; and
receiving, from the shipper, an acceptance of a bid from a winning carrier or brokers, and notifying the winning carrier or brokers of the acceptance.

15. The computerized method of claim 14 further comprising:
receiving a bid with equipment from the matching carriers or brokers; and
receiving a bid without equipment from the matching carriers or brokers.

16. The computerized method of claim 14, wherein comparing the plurality of carrier or brokers profiles to the load criteria comprises comparing geographic transport preferences to the load pickup and delivery points.

17. The computerized method of claim 14, further comprising:
sending reminder notification to a shipper who posted a load and a carrier who hauled the load to input performance rating to one another; and
making the performance rating of the shipper and carrier available to all registered shippers. carriers and brokers.
